(19) United States
(12) Patent Application Publication
(10) Pub. No.: US 2007/0226251 A1
(43) Pub. Date: Sep. 27, 2007

(54) METHOD OF AUGMENTING AND CONTROLLING UTILITY PROGRAM EXECUTION FOR A RELATIONAL DATABASE MANAGEMENT SYSTEM

(75) Inventors: Gregory C. Grounds, Austin, TX (US); Vernon F. Huxoll, Austin, TX (US)

Correspondence Address: BARLOW, JOSEPHS & HOLMES, LTD., 101 DYER STREET, 5TH FLOOR, PROVIDENCE, RI, 02903, US

(73) Assignee: ROCKET SOFTWARE, INC., Newton, MA (US)

(21) Appl. No.: 11/277,373

(22) Filed: Mar. 24, 2006

(51) Int. Cl. G06F 17/00

(52) U.S. Cl. 707/103 R

(57) ABSTRACT

A control module for augmenting and controlling utility program execution for a relational database management system (“RDBMS”), such as DB2, and method thereof are disclosed. The control module analyzes the utility control statements and takes actions, such as canceling selected application threads, according to a user-specified policy. Using a linkage editor, the control module is linked as the entry point into a utility program load module from a program library of the RDBMS, and the resulting modified load module is stored in place of the original utility program load module in the program library. The receiving of a utility control statement that invokes the utility program, invokes the control module prior to invoking the utility program.

### BACKGROUND OF THE INVENTION

1. Field of the Invention

The present invention relates generally to relational database management systems (“RDBMS”) and more particularly to augment and control utility execution for the program product DB2 for z/OS, which is a RDBMS created by IBM.

2. Background of the Related Art

RDBMS generally include management utilities to assist the IT professional with the day to day arduous task of maintaining the integrity of the database and data contained therein. These tasks include loading a table, copying a table space, or recovering a database to a previous point in time to name a few. DB2 for z/OS is no different in this respect. IBM publishes a well-known reference and user manual for DB2 called the “DB2 Universal Database for z/OS Version 8: Utility Guide and Reference”, which is incorporated herein by reference, that describes all of the management utilities available in DB2.

In DB2, these management utilities come in two varieties—stand-alone utilities and online utilities. Online utilities may be invoked by a properly formatted utility control statement in a job control language (“JCL”) and may be run in batches with at least one separate utility being called sequentially. Online utilities may also be invoked by calling the DB2 supplied stored procedures DSNUTILS or DSNUTILU. Online utilities may also be invoked by calling the DSNUTILB program from any other program. Stand-alone utilities run independently of DB2. The online utilities require that DB2 is running.

Programming JCL commands and scripts is a tedious task, which is further complicated by the fact that any error in the JCL will cause the command or script to abort or malfunction. However, JCL is essential to automate many management tasks in DB2. Therefore, it would be advantageous to minimize the need to edit JCL commands and scripts to avoid the tedious task and prevent introduction of errors into the scripts.

One particularly important utility is the DSNUTILB program, which provides for batch processing of utility control statements to run a number of important utility functions to manage a DB2 RDBMS. DSNUTILB is a control program that processes utility control statements that result in the execution of a specific utility function or task. DB2 utilities can dynamically create object lists from a pattern-matching expression and can dynamically allocate the data sets required to process those objects.

Within a RDBMS that supports multiple simultaneous connections, applications may be running simultaneously on data contained in the RDBMS. Each of the application threads execute separately, but may share the same resources of the RDBMS. These applications can have a variety of functions and can be run by a variety of users including RDBMS users and/or administrators of the system. It is often the case that application processes block utility access to RDBMS resources. In order for the utility to continue processing, the application thread might need to be identified and terminated.

To reallocate resources effectively and terminate these application threads, system administrators often have to identify and terminate them by hand using RDBMS commands. This task can be time consuming and especially onerous. Accordingly, the prior art suffers from the disadvantage of having to manually manage and terminate multiple threads executing concurrently within a RDBMS environment.

To provide an ability to automate certain desired processes, such as the termination of application threads (which is often necessary because application threads may block access to RDBMS resources needed by a utility program), one encounters several disadvantages. One solution is to create a program and call it from a JCL script. This program, however, is a separate stand-alone program that must be called prior to the desired utility and does not intercept and preprocess the utility control statements. Because this program is a separate utility in and of itself, this solution necessarily involves rewriting the RDBMS' JCL scripts to include a call to this add-on program prior to the desired utility or as a call to the add-on program that passes the utility control statement as an argument. On a typical RDBMS system, there may be hundreds of thousands of lines of code in JCL scripts that would need to be edited to facilitate the inclusion of a separate add-on control module. Needless to say, this solution suffers from the disadvantage of being prohibitively expensive in time and cost to implement properly. Even if the time and effort are invested in the project, inevitably errors are introduced into the JCL scripts causing them to malfunction.

Therefore, it would be desirable and advantageous to have the ability to preprocess utility control statements prior to invocation of the utility program without regard to how the utility program is invoked. Additionally, there is also a need for an efficient and automated system for terminating threads to reallocate the computing resources of the RDBMS for critical utility functions.

Moreover, the task of managing a utility job stream in general is lacking in DB2 and other RDBMS. In particular, these systems lack the ability to customize the security settings, the ability to manage the execution of utilities, the ability to track and create an intelligible audit trail for administrative purposes, and the ability to further augment and control utility program execution.

### SUMMARY OF THE INVENTION

The present invention provides a method of augmenting and controlling utility program execution for a RDBMS, like DB2. More specifically, the present invention solves the problems of the prior art by providing a method for intercepting the utility control statements and also by providing a control module for analyzing the utility control statements and taking actions, such as canceling threads, according to a user specified policy. Using a linkage editor, the control module is linked as the entry point into a utility processor module or control program from a load library of the RDBMS. The resulting load module may be stored in any library such that the modified utility program is loaded and executed when an attempt is made to execute the original utility program. The resulting load module may be stored in place of the original utility processor or control program in the RDBMS load library. When the utility module is executed, the control module receives initial control. As a result, utility control statements that are provided as input to the utility processor or control program may be read, parsed and subsequent actions performed.

Other useful functions that the present invention provides is the ability to provide a custom or augmented security layer that surrounds utility execution and the ability to manage the timing of execution of a series of utilities. Moreover, the present invention can provide an audit trail of the utility execution for purposes of diagnosing system problems, security flaws and other useful administrative purposes.

In the case of DB2, the control module can be relinked into the DSNUTILB control program and can be configured to cancel threads so that computing resources may be reallocated to the utility process designated in the utility control statement.

In particular, the method of the present invention of preprocessing utility control statements for a RDBMS first includes providing a control module for analyzing the utility control statements and taking actions according to a user specified policy. Next, using a linkage editor, the control module is relinked as the entry point into the utility processor or control program to form a modified utility load module. The modified utility load module replaces the utility load module in the load library of the RDBMS. When the utility processor or control program is executed, the control module gains control prior to invoking the utility function.

Accordingly, among the objects of the present invention is the provision for a method of relinking a control module as the entry-point into a utility processor or control program to provide for utility control statement preprocessing.

Another object of the present invention is the provision for a method of preprocessing utility control statements.

Yet, another object of the present invention is the provision for a method of automatically terminating conflicting application threads without the need for user intervention, thereby automating this once tedious and manual task.

Yet, another object of the present invention is the provision for a method for providing an augmented or custom layer of security around utility execution.

Another object of the present invention is the provision for a method of controlling the timing of utility execution.

Yet, another object of the present invention is the provision for a method to augment utility operation.

### BRIEF DESCRIPTION OF THE DRAWINGS

These and other features, aspects, and advantages of the present invention will become better understood with reference to the following description, appended claims, and accompanying drawings where:

FIG. 1 is a diagram of the method of the present invention;

FIG. 2 is a diagram of the modified utility module of the present invention; and

FIG. 3 is a flowchart of the method of preprocessing utility control statements with the control module of the present invention.

### DESCRIPTION OF THE PREFERRED EMBODIMENT

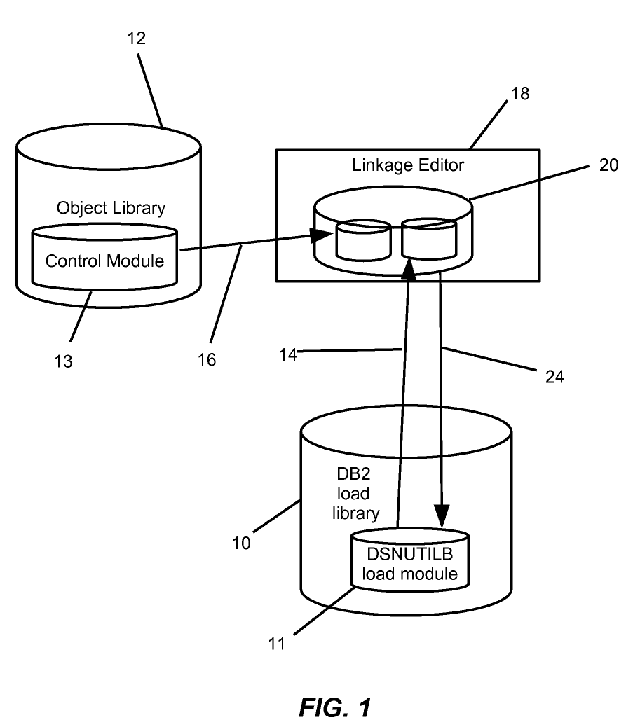

Referring first to FIG. 1, a method of intercepting and processing utility control statements for a RDBMS is shown. In accordance with the present invention there is provided a program library 10 having at least one utility program 11. Also provided is an object library 12 having a control module 13. At least one utility program 11 and the control module 13 are included 14, 16 into a linkage editor 18 and linked together to form a modified utility program 20. Preferably, the modified utility program 20 is then stored 24 in the program library 10 and replaces the original utility program 11. The modified utility program 20 could be stored in any other desired location instead of the program library 10, so long as it is executed rather than the original utility program 11.

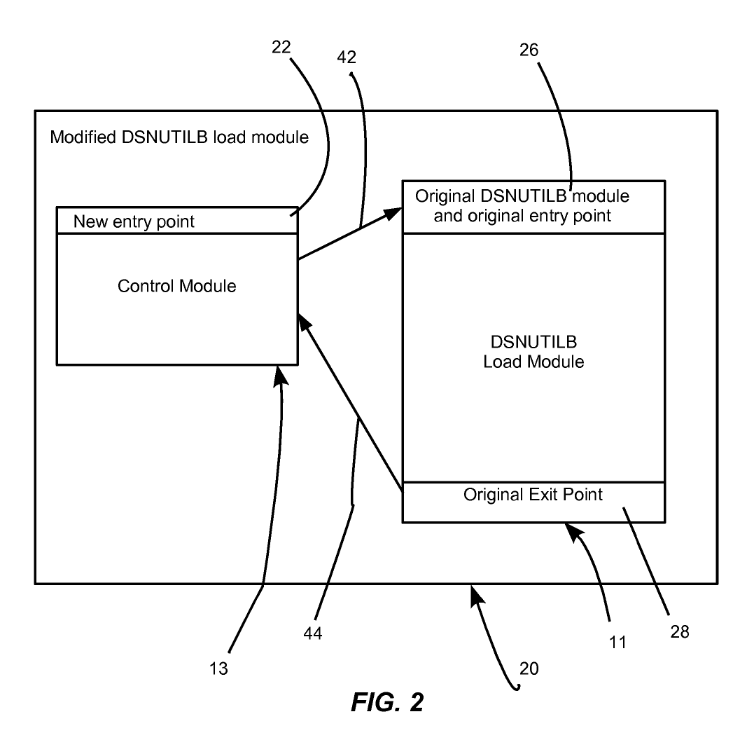

Referring to FIGS. 1 and 2, the present invention is described in detail with regard to practicing the invention in the case of DB2. Although the invention is described in detail with regard to DB2, it is to be understood that the utility program of the present invention may be applied to other RDBMS running on other platforms. The DSNUTILB load module 11 provides for the processing of utility control statements. The original DSNUTILB load module 11 and control module 13 are included 14, 16 in a linkage editor 18. The DSNUTILB load module 11 and control module 13 are linked together to form a modified DSNUTILB load module 20. The control module 13 is set as the entry point 22 into the DSNUTILB load module 20. The modified DSNUTILB load module 20 is stored 24 by the linkage editor 18 into the original DB2 load library 10.

As shown in FIG. 2, the modified DSNUTILB load module 20 contains both the original DSNUTILB load module 11 and the control module 13. As mentioned earlier, the control module 13 has been specified by the linkage editor 18 to be the entry point 22 of the modified DSNUTILB load module 20. The original entry point 26 into the DSNUTILB load module 11 is retained so that the control module 13 may call, at step 42 described further below, the DSNUTILB load module 11 to execute the original request in the utility control statement.

The original exit point 28 of the DSNUTILB load module 11 returns program control, at step 44 described further below, to the control module 13 after the DSNUTILB load module 11 completes execution.

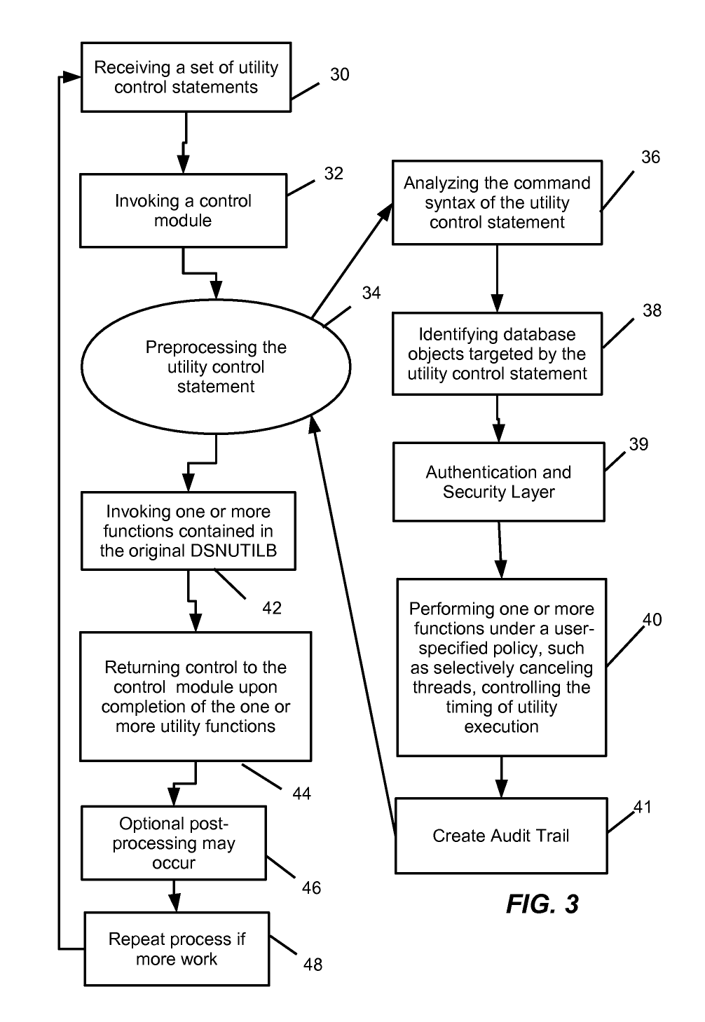

Referring now to FIG. 3 and back to FIGS. 1 and 2, the process of the present invention is shown first, upon receiving, at step 30, a set of utility control statements that call utility functions within the DSNUTILB load module 11 and other load modules (not shown), the control module 13 executes, at step 32, first, as shown. The control module 13 preprocesses, at step 34, the utility control statements by analyzing, at step 36, the command syntax of the utility control statement to identify the desired action or actions to be taken. The control module 13 also identifies, at step 38, the database objects that are the target of the utility control statement.

At step 39, the control module 13 of the present invention can include the ability to provide a custom security layer around utility program 11 execution. In particular, the control module 13 can provide for a user authentication scheme and a system-level policy control of categories of users and available actions. As can be appreciated, this enables the control module 13 to allow only certain authorized users to execute certain utilities thereby protecting the integrity of the RDBMS.

After performing the analysis, at step 36, of the command syntax and identifying, at step 38, the targets of the utility control statement, and optionally performing any security and/or authentication, at step 39, the control module 13 performs, at step 40, any necessary actions according to the user specified policy, including performing no action at all. In particular, the control module 13 can identify and cancel application threads, at step 40, in order to terminate conflicting application threads and also to free computing resources for the RDBMS to perform the actions requested in the utility control statement.

For instance, if the utility control statement is requesting that data be loaded into a particular table of the RDBMS, any threads accessing that particular table must be terminated prior to the load. Threads that are running utilities that are allowed to run concurrently with the designated action in the utility control statement may, of course, be allowed to run without being terminated. The important aspect of the present invention is that the control module 13 can identify and terminate these conflicting threads without user intervention. After the appropriate threads have been terminated, the control module 13 can invoke, at step 42, in FIG. 3, the original functions requested in the utility control statement for the original DSNUTILB load module 11, or other utility load modules. After the requested DSNUTILB function terminates, control is returned 44 to the control module 13 and any necessary post-processing, at step 46, may occur, as desired. At step 48, the process repeats for additional utility control statements received.

In addition to selectively cancelling threads, the control module 13 of the present invention can also control the timing of utility execution, at step 40. This can be done to allow execution of other critical functions to complete prior to execution of a utility program 11. Instead of cancelling a particular thread, the control module 13 can allow the thread to complete execution first prior to execution of the utility program 11. This feature is configurable according to the user level and system level policies that may be set as desired.

At step 41, the control module 13 can also provide an audit trail of utility execution that may include many parameters including user identification, when the utility was run, which utility was run (including input parameters), and the utility exit code, among others. The audit trail is useful for a number of purposes including debugging and security investigation to name a couple.

Although the method of the present invention has been described with respect to using the DSNUTILB load module of the DB2 RDBMS, other load modules may be used. Moreover, one skilled in the art would appreciate that the method of the present invention may be applied to other utility programs of other RDBMS to effect preprocessing of utility control statements therefor.

Therefore, it can be seen that the present invention provides a unique solution to the problem of avoiding changes to the invocation of the utility program by providing a control module that is linked into the utility load library of the RDBMS that intercepts and preprocesses the utility control statements prior to executing the desired utilities. The method of the present invention also enjoys the benefit of automating the tedious task of manually terminating conflicting threads for a RDBMS that supports multi-threaded operations.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method of augmenting and controlling utility program execution initiated by utility control statements for a relational database management system, comprising the steps of:
providing a control module for analyzing the utility control statements and taking actions according to a user specified policy;
providing a utility program from the relational database management system;
relinking the control module as the entry point into the utility program to form a modified utility program; and
replacing the utility program with the modified utility program in the relational database management system;
whereby the modified utility program's receipt of a utility control statement, invokes the control module prior to invoking the utility program linked within the modified utility program.

2. The method of claim 1, wherein the relational database management system is a DB2 relational database management system.

3. The method of claim 2, wherein the utility program is the DSNUTILB load module.

4. The method of claim 1, wherein at least one application thread is running within said relational database management system; and
said control module selectively canceling said at least one application thread.

5. The method of claim 1, further comprising the step of:
providing a custom security layer around the utility program linked within the modified utility program execution.

6. The method of claim 1, further comprising the step of:
controlling the timing of the utility program linked within the modified utility program execution.

7. The method of claim 1, further comprising the step of:
creating an audit trail of the utility program linked within the modified utility program execution.

8. A method of augmenting and controlling utility execution initiated by utility control statements for a relational database management system, comprising the steps of:
receiving a utility control statement to execute at least one utility program of the relational database management system;
invoking a control module upon entering the at least one utility program and prior to executing the at least one utility program;
preprocessing the utility control statement;
invoking the at least one utility program;
returning control to the preprocessing module upon completion of the at least one utility program.

9. The method of claim 8, wherein the utility control statement has a command syntax, the command syntax identifying at least one database object of the relational database management system; and
said step of preprocessing the utility control statement further comprises the steps of:
analyzing the command syntax of the utility control statement;
identifying at least one database object targeted by the utility control statement; and
performing at least one preprocessing function under a user-specified policy.

10. The method of claim 8, further comprising the step of:
providing a custom security layer around the at least one utility program execution.

11. The method of claim 8, further comprising the step of:
controlling the timing of the at least one utility program execution.

12. The method of claim 8, further comprising the step of:
creating an audit trail of the at least one utility program execution.

13. The method of claim 8, wherein the relational database management system is a DB2 relational database management system.

14. The method of claim 13, wherein the utility program is the DSNUTILB load module.

15. The method of claim 8, wherein at least one application thread is actively running within said relational database management; and
said step of preprocessing the utility control statement further includes canceling the at least one application thread.

16. A method of augmenting and controlling utility execution initiated by utility control statements for a DB2 relational database management system, comprising the steps of:
receiving a utility control statement to execute a DSNUTILB load module to perform a function;
invoking a control module upon entering the DSNUTILB load module and prior to executing the DSNUTILB load module to perform the function;
preprocessing the utility control statement;
invoking the DSNUTILB load module to perform the function;
returning control to the control module upon completion of the DSNUTILB load module.

17. The method of claim 16, wherein at least one application thread is actively running within said DB2 relational database management system; and
said utility control statement further including a command syntax targeting at least one database object of said DB2 relational database management system;
said step of preprocessing the utility control statement further comprising the steps of:
analyzing the command syntax of the utility control statement;
identifying the at least one database object targeted by the utility control statement; and
performing at least one preprocessing function under a user-specified policy.

18. The method of claim 16, further comprising the step of:
providing a custom security layer around the DSNUTILB load module execution.

19. The method of claim 16, further comprising the step of:
controlling the timing of the DSNUTILB load module execution.

20. The method of claim 16, further comprising the step of:
creating an audit trail of DSNUTILB load module execution.

21. The method of claim 16, wherein at least one application thread is actively running within said DB2 relational database management system and
said step of preprocessing the utility control statement further includes canceling at least one application thread.
